(19) United States
(12) Patent Application Publication
(10) Pub. No.: US 2025/0317761 A1
(43) Pub. Date: Oct. 9, 2025

(54) MACHINE LEARNING ASSISTED COMMUNICATION TOOL

(71) Applicant: PeaceProject.ai LLC, Studio City, CA (US)

(72) Inventors: David Golden, Studio City, CA (US); Arielle Parker Hanien, Studio City, CA (US)

(73) Assignee: PeaceProject.ai LLC, Studio City, CA (US)

(21) Appl. No.: 19/174,295

(22) Filed: Apr. 9, 2025

Related U.S. Application Data
(60) Provisional application No. 63/631,908, filed on Apr. 9, 2024.

(51) Int. Cl. H04W 24/02; H04L 41/14

(52) U.S. Cl. CPC H04W 24/02; H04L 41/145

(57) ABSTRACT

Systems and methods for providing a machine learning assisted communication tool are provided. A method for using machine learning to aid communication may include: receiving inputs, via a user input device, the received inputs including: a message input indicative of a message to be communicated; and one or more contextual inputs associated with the message to be communicated, each contextual input having an associated context type; generating a prompt based at least in part on the received inputs and the associated context types of the one or more contextual inputs; and determining, using a machine learning model, one or more outputs associated with the message to be communicated based at least in part on the generated prompt, at least one output of the one or more outputs being a message output indicative of the message to be communicated based at least in part on the received inputs.

### CROSS-REFERENCE TO RELATED APPLICATIONS

This application claims priority under 35 U.S.C. § 119 (e) to and is a non-provisional application of U.S. Patent Application Ser. No. 63/631,908, filed Apr. 9, 2024, entitled “MACHINE LEARNING ASSISTED COMMUNICATION TOOL,” the entire contents of which are incorporated herein by reference.

### SUMMARY

According to some aspects described herein, a method for using machine learning to aid communication is provided. The method comprises: receiving inputs, via a user input device, the received inputs including: a message input indicative of a message to be communicated; and one or more contextual inputs associated with the message to be communicated, each contextual input having an associated context type; generating a prompt based at least in part on the received inputs and the associated context types of the one or more contextual inputs; and determining, using a machine learning model, one or more outputs associated with the message to be communicated based at least in part on the generated prompt, at least one output of the one or more outputs being a message output indicative of the message to be communicated based at least in part on the received inputs.

In some embodiments, the prompt comprises a plurality of prompt clauses, and generating the prompt comprises generating at least a subset of prompt clauses of the plurality of prompt clauses based on the received inputs and the associated context types of the one or more contextual inputs.

In some embodiments, at least one prompt clause of the plurality of prompt clauses is generated based at least in part on information associated with a user of the user input device.

In some embodiments, the information associated with the user of the user input device is indicative of a user group the user is part of and/or of a relationship of the user to the user group.

In some embodiments, the prompt is a first prompt, and the method further comprises: receiving, as input to the machine learning model, a second prompt, the second prompt being indicative of one or more metrics of the message input and/or the message output to be evaluated; evaluating, using the machine learning model, the one or more metrics of the message input and/or the message output; and providing the evaluated one or more metrics to a user of the user input device.

In some embodiments, the one or more metrics include one or more of: actionability, assertiveness, brevity, clarity, dignity, empathy, persuasiveness, relevance, structure, and/or tone. In some embodiments, at least a subset of outputs of the one or more outputs includes feedback outputs configured to coach a user of the user input device to improve communication skills.

In some embodiments, the feedback outputs include at least one or more of: a changes output indicative of the changes between the message input and the message output, an analysis output indicative of one or more issues with the message input or message output, and/or a suggestions output indicative of steps to be taken by the user.

In some embodiments, one or more feedback outputs of the feedback outputs is indicative of one or more additional inputs to be provided by the user, and the method further comprises: receiving the one or more additional inputs, via the user input device, in response to the one feedback output; updating the prompts based at least in part on the one or more additional inputs; and determining, using the machine learning model, a new set of one or more outputs based at least in part on the updated prompt.

In some embodiments, one feedback output of the feedback outputs is one or more predicted responses to the message to be communicated.

In some embodiments, the method further comprises: outputting, using an audio output device, an audio signal indicative of the predicted responses, wherein the audio signal is in a voice of an intended recipient of the message to be communicated and/or using a visual output device, a video signal indicative of the predicted responses and/or using an audiovisual device, a combined audiovisual signal indicative of the predicted responses or the intended recipient to the message to be communicated.

In some embodiments, a contextual input of the one or more contextual inputs is a language input indicating whether the message output is to be translated into a language and the message output is generated based at least in part on information associated with the language, the method further comprising: translating the message output into the language if the language input indicates that the message output be translated into the language; and translating the message output into a language of the user.

In some embodiments, one output of the one or more outputs comprises translation notes indicative of information associated with the language and information associated with translating the message output into the language.

In some embodiments, the method further comprises: validating the received user inputs by providing the received user inputs to a language identification model; receiving a validation metric indicating whether the received user inputs are valid; and providing an error message to the user if the validation metric indicates that user inputs are invalid.

In some embodiments, the validation metric comprises a language and/or confidence score and the received user inputs are indicated as valid if the language is supported and/or the confidence score is within a threshold range.

In some embodiments, the method further comprises presenting, to a user within a computer-generated interface, a plurality of user interface controls that, when activated, permit the user to provide the one or more contextual inputs associated with the message to be communicated.

In some embodiments, a first interface control of the plurality of interface controls is indicative of the user responding to a message to be replied to and the user interface is configured to provide a textbox for the user to input the message to be replied to.

In some embodiments, at least one input of the received inputs is stored in a memory and receiving inputs comprises receiving an input via the user input device associated with the stored input and receiving the stored input from the memory.

In some embodiments, at least one output of the one or more outputs is stored in the memory and the memory is configured to accessed by a user via the user input device to allow the user to review and/or share the at least one stored input and/or the at least one stored output.

In some embodiments, the method further comprises: receiving, from the user input device, a feedback input responsive to the one or more outputs; and updating the machine learning model based at least in part on the feedback input. In some embodiments, the feedback input is indicative of an effectiveness of the message output.

In some embodiments, at least one of the one or more contextual inputs is received from one or more communication platforms with which the user has an account when the user input is indicative of authorization to access the one or more communication platforms. In some embodiments, the method further comprises: providing a user of the user input device a user interface for providing inputs when the user input device is executing a text-based application of the user input device.

According to some aspects described herein, A machine learning assisted communication tool is provided. The machine learning assisted communication tool comprises: a user input device configured to receive one or more inputs from a user, the received inputs including: a message input indicative of a message to be communicated; and one or more contextual inputs associated with the message to be communicated, each contextual input having an associated context type; and one or more processors configured to: generate a prompt based at least in part on the received inputs and the associated context types of the one or more contextual inputs; and determine, using a machine learning model, one or more outputs associated with the message to be communicated based at least in part on the generated prompt, at least one output of the one or more outputs being a message output indicative of the message to be communicated based at least in part on the received inputs.

According to some aspects described herein, a non-transitory computer readable medium storing processor-executable instructions, that, when executed, cause the processor to perform a method is provided. The method comprises: receiving inputs, via a user input device, the received inputs including: a message input indicative of a message to be communicated; and one or more contextual inputs associated with the message to be communicated, each contextual input having an associated context type; generating a prompt based at least in part on the received inputs and the associated context types of the one or more contextual inputs; and determining, using a machine learning model, one or more outputs associated with the message to be communicated based at least in part on the generated prompt, at least one output of the one or more outputs being a message output indicative of the message to be communicated based at least in part on the received inputs.

According to some aspects described herein, a method for using machine learning to aid communication is provided. The method comprises: receiving inputs, via a user input device, the received inputs including: a message input indicative of a message to be communicated; and one or more contextual inputs associated with the message to be communicated, each contextual input having an associated context type; generating a prompt based at least in part on the received inputs; determining, using a machine learning model, one or more outputs associated with the message to be communicated based at least in part on the generated prompt and the associated context types of the contextual inputs received, wherein a number of outputs is determined based at least in part on the associated context types of the contextual inputs received.

According to some aspects described herein, a method for using machine learning to coach a user is provided. The method comprising: providing an interface on a user input device tailored to the user; prompting a user, via a user input device, for inputs; receiving inputs from the user, via the user input device, each input comprising content and a context type; generating a model input based at least in part on the content and context type of each input; and determining, using a machine learning model, one or more outputs associated with the received inputs based at least in part on the generated model input and the context types of each input, wherein at least one output of the one or more outputs is configured to coach the user to improve one or more skills of the user; providing one or more outputs in text, audio, visual, and/or audiovisual form responsive to the user selecting text, audio, visual, and/or audiovisual form; receiving updated inputs from the user, via the user input device, responsive to at least one output configured to coach the user; and updating the model input based at least in part on the updated inputs.

### BRIEF DESCRIPTION OF THE DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 is a block diagram of an example system for implementing a machine learning assisted communication tool, according to some embodiments;

FIG. 2A depicts a flow chart illustrating an example method for generating one or more outputs associated with a message to be communicated using a machine learning assisted communication tool, according to some embodiments;

FIG. 2B depicts a flow chart illustrating an example method for dynamically generating a prompt, according to some embodiments.

FIGS. 3A-B depict an example user interface for providing one or more content and contextual inputs to a machine learning assisted communication tool, according to some embodiments;

FIG. 4A depicts an example display providing one or more metrics associated with a message to be communicated, according to some embodiments;

FIG. 4B depicts another example display providing one or more metrics associated with a message to be communicated, according to some embodiments;

FIG. 5A depicts an example display providing one or more outputs associated with a message to be communicated generated by a machine learning assisted communication tool, according to some embodiments;

FIG. 5B depicts an example display for linking a persona with a communication platform, according to some embodiments;

FIG. 6 depicts an example computer-based system on which the system of FIG. 1 may be implemented, according to some embodiments.

### DETAILED DESCRIPTION

In the increasingly digitalized world, communication both within and between different groups of people has become significantly more accessible, whether they be within the same community or different communities. However, the pace of communications, the risks, and the challenges, are unprecedented. For example, friends or co-workers may communicate over various forms of communication, including telephone calls, text, social media, email, etc., all of which may be done using different communication styles and tones that are content or context-specific. In-person communications have always been challenging, such as communication between parties with preexisting tensions which may distort perceptions or when information is sensitive, for example when a doctor may need to communicate certain news to a patient. Bad news and good news may each warrant different communication styles and methods of communication. Differences between cultural norms also complicate communication, even when language translation resources are readily available. And for some individuals, or in some settings, bias, perceived threat, or psychological disorders have a tendency to distort messages received.

Machine learning and artificial intelligence (AI) may aid people in effectively communicating with each other in various situations. For example, a machine learning model may be able to generate or modify the content and format of a particular message drafted by a user for a particular use case so as to enable a person to more effectively achieve the goal of that message. However, the inventors have recognized and appreciated that the current state of machine learning/AI communication tools fails to account for the multitude of circumstances and situations in which communication is entailed or for special challenges in using machine learning/AI communication tools under stress or for untrained users who need to increase literacy in certain areas in order to compose effective prompts. Conventional machine learning/AI tools may typically utilize static prompts that are effective in very limited situations or may require the user to fully generate the instructions for the machine learning model in real time. However, LLM users may not be able to effectively generate a prompt to receive a particular output needed to aid their communication if their circumstances are unique, if they are under pressure, if their focus or perspective are compromised by emotion or bias, or if their understanding of effective communication principles or their audience is limited. As such, the inventors have developed methods and systems for dynamically generating prompts for use as input to a machine learning model in order to effectively generate message outputs needed by a user in an optimized way and to teach the user about effective communication by modeling and explaining the ways in which the AI/machine learning is working with the information provided by the user, including the user's initial draft, stated goals and concerns, contextual details.

Users in a particular group may have access to one or more web forms which may provide a customizable interface for generating an optimized prompt. The interface may collect important information from the user to dynamically modify the system's initial prompt for the user's particular use case. The resulting, more specialized prompt may return structured data that is similarly dynamic, allowing for the outputs of the machine learning model to vary based on the various information inputted by the user. The initial and more specialized prompts may also incorporate various information specific to a user, a user's group(s) such as companies or organizations, and the user's relationship to the group, so as to facilitate customization of the user interface and support the user experience in a variety of ways, including addressing a variety of use cases for different groups.

While dynamically generated prompts provide an effective tool to aid communication in a variety of situations, the use of dynamically generated prompts is not limited to that particular use, and dynamically generated prompts may be used to facilitate other use cases, including, but not limited to, movie or travel recommendations, parenting or diplomatic advice, photograph, video, and/or audio generation, gaming, and/or any of many other suitable use cases.

As will be discussed and described further herein, according to some aspects described, systems and methods are provided that provide functions relating to dynamic prompt generation. These functions may be useful in more accurately generating highly specialized, complex prompts which produce more helpful, useful, and relevant output and in more accurately controlling output from a machine learning model such as a large language model (LLM) or other interactive system type to more effectively avoid hallucinations. In some implementations, the prompt generation functions may be useful for generating content specific to a user, group, or combination thereof. Specific prompt clauses may be used to highly customize the prompt input and may be used to define, and structure expected outputs, to more accurately control the interactive system. In one example, prompt clauses may be provided to control what the interactive system produces from the prompt, and to control the output provided to the user. For instance, prompt clauses may control a context of the message, such as “This user is a leader in our organization and needs to speak with this in mind.” To this end, the system may include one or more interface controls to accept these inputs and to provide a structured output as the prompt to the interactive system.

In some implementations, the messages themselves (input, output, AI-generated, etc.) may be measured in one or more dimensions, such as a measurement of the extent to which a message is “actionable.” For example, in an actionability dimension, the system is configured to calculate a measurement of the extent to which the message (input, output, or otherwise) prompts action or decision-making. Relatively high scores of an actionability dimension are for messages that clearly outline recommended actions or decisions.

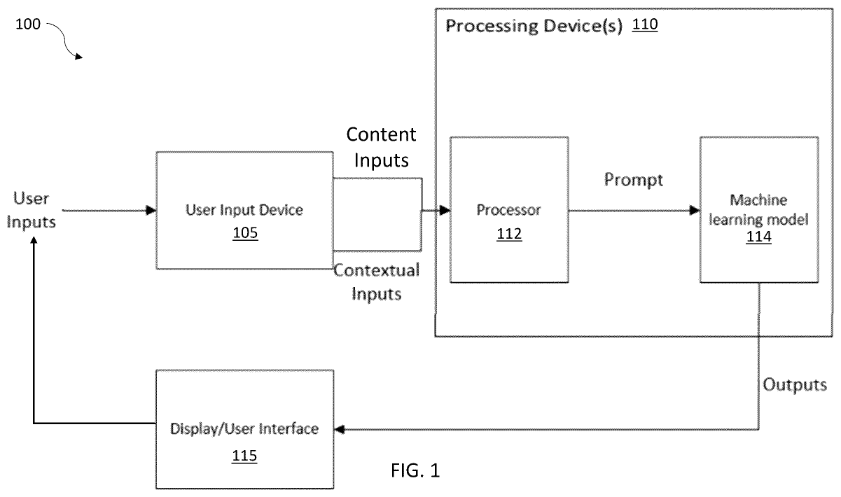

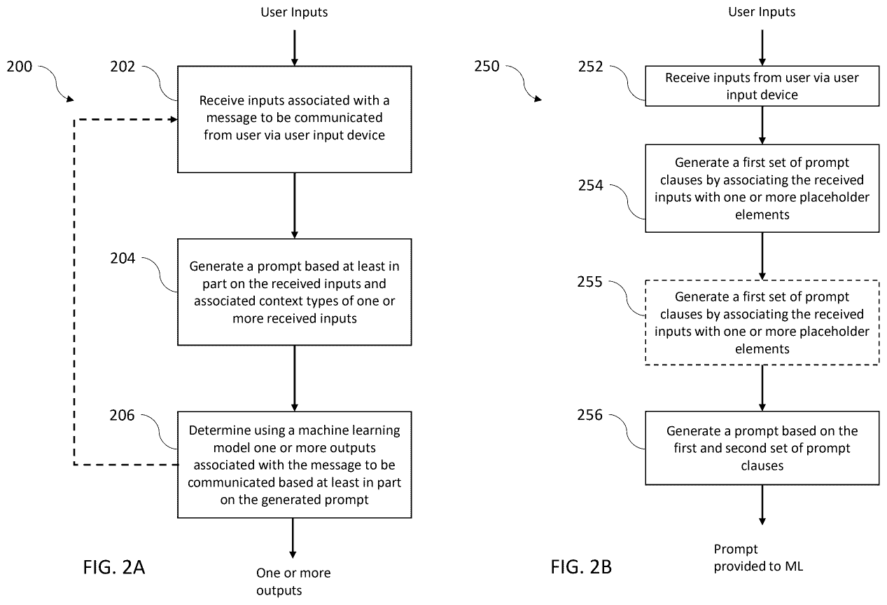

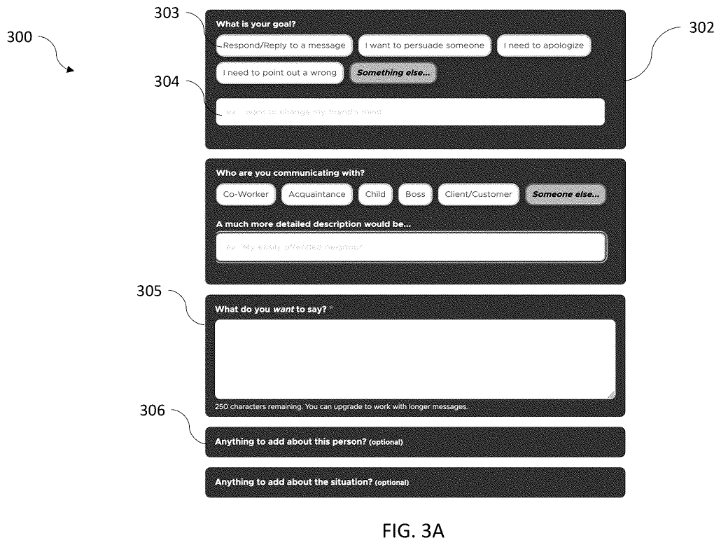

FIG. 1 is a block diagram of an example system 100 for implementing a machine learning assisted communication tool, according to some embodiments. In the illustrated embodiment, system 100 includes user input device(s) 105, processing device(s) 110, and user interface(s) 115. FIG. 2A depicts a flow chart illustrating an example method 200 for generating one or more outputs associated with a message to be communicated using a machine learning assisted communication tool, according to some embodiments;

At act 202, method 200 begins by receiving one or more inputs from a user via a user input device 105. User input device 105 may include any suitable input device or combination thereof. For example, user input device 105 may include one or more of: a mouse, touchpad, touch screen, keyboard, audio input device (e.g., microphone), optical input device (e.g., camera, optical sensor), or any other suitable input device. User input device 105 may be configured to receive one or more user inputs associated with a message to be communicated. For example, a user may provide one or more content inputs indicative of the message to be communicated as well as one or more contextual inputs that can be used to inform a machine learning model (e.g., ML model 114) to better generate message outputs. User input device 105 may provide the received user inputs (content inputs and/or contextual inputs) to processing device(s) 110.

Having received the one or more inputs from the user, at act 204, a prompt may be dynamically generated based at least in part on the received inputs and associated context types of one or more received inputs. Processing device(s) 110 may include one or more processors 112 for performing any of the functionality herein, for example, dynamic prompt generation. As will be described further below, processor 112 may dynamically generate a prompt based on the various user inputs received from user input device 105. For example, processor 112 may receive one or more content inputs indicative of the message to be communicated and one or more contextual inputs associated with the message to be communicated to provide additional context to be used by the machine learning model.

Once the prompt is generated, at act 206, the prompt may be provided to a machine learning model to determine one or more outputs associated with the message to be communicated based at least in part on the generated prompt.

Processing device 110 may additionally include a machine learning model 114 for performing any of the functionality described herein, for example, rewriting a message to be communicated, evaluating messages to be communicated, or any other suitable functionality. Machine learning model 114 may be executed by processor 112 or may be executed independently and operatively coupled with processor 112. In that way, machine learning model 114 may be configured to receive any suitable information for generating one or more outputs (e.g., message outputs) from processor 112. In some embodiments, machine learning model 114 may be any suitable machine learning model including but not limited to a deep learning model, neural network, convolutional neural network, large language model (LLM), large action model (LAM), or any other suitable machine learning model.

The one or more outputs generated at act 206 by machine learning model 114 may be output to the user in any suitable manner. For example, the outputs may be provided to the user as one or more displays in user interface 115. User interface 115 may include any suitable output device for outputting the one or more outputs, including but not limited to, visual output devices (e.g., screen or other display) and audio output devices (e.g., speakers, earbuds, headphones). Although illustrated as a separate component, user interface 115 may be implemented together or operative coupled with user input device 105.

### Dynamic Prompt Generation

As discussed above, conventional methods of generating prompts for machine learning models based on user input may typically use a static prompt. A reusable prompt may be generated which includes placeholders for disparate user inputs in a long and complex prompt. For example, a prompt may include the placeholder [my_age] to represent a term in the prompt for the user's age so that users of different ages may use the same prompt. Once any user inputs their age using an input device, the placeholder [my_age] may be replaced in the prompt with the age value entered by the user. However, regardless of the number of placeholders, a static prompt will not be adaptive to all possible relevant use cases. Further, if too many placeholders are required, then using a static prompt may become more of a burden than a convenience, with diminishing returns on their utility in light of the burden on a user of filling in all placeholder fields.

For complex use cases, machine learning model (e.g., large language model (LLM)) users may generate very lengthy and complex unique prompts in order to address all relevant details of a unique situation or alternatively may refine a more basic prompt in an iterative process whereby the user offers new prompts to modify the output generated by the AI in response to the initial or prior prompt. In both cases, the quality of the output may depend on the LLM user's skill in crafting prompts, relevant knowledge and perspective, and ability to function optimally in real time. However, crafting a lengthy, complex prompt or refining a prompt through an iterative process can be so burdensome in real time even when an LLM user is highly skilled and functional, as to diminish or undermine the value of the effort invested in that process. While a long, complex prompt that is optimized for one situation can be tested and stored for future use, a complex prompt that is optimized for one situation may not be optimized for others. Further, even if thousands of extensive prompts were to be indexed, LLM users may have to spend time searching for the appropriate one and may find at best one that is an approximate match to their unique situation/use case. Thus, in light of the infinite variability of situations, styles, purposes, and challenges in the realm of communication, the inventors have recognized and appreciated that relying upon a static prompt may profoundly limit the utility/value of a machine learning model as a tool for aiding communication. For a different static prompt would be needed in order to produce the desired output in a way optimized for each circumstance, purpose, style, goal, or challenge involved. Accordingly, in order to increase the utility of text based generative machine learning models, the inventors have developed methods and systems for dynamically generating prompts in real time allowing for more dynamism in inputs and outputs of a communication tool, increasing utility, efficacy, and ease of use, and empowering the user by supporting users in learning concepts, skills, and self-awareness through the use of the tool in ways that may change users' knowledge, thought processes, and behavior.

In some aspects described herein, a method for dynamically generating prompts for input to a machine learning model may be provided. FIG. 2B depicts a flow chart illustrating an example method 250 for dynamically generating a prompt, according to some embodiments. The prompt may include one or more prompt clauses, each prompt clause associated with various information or instructions for the machine learning model to be included in the prompt.

At act 252, one or more inputs from the user may be received, for example, from user input device 105. In some examples, user input device 105 may be configured to enable a user to fill out a web form may be presented to a user. For example, the web form may be part of a website tool, mobile application, or any other suitable web form or a separate application or plug-in. The web form may be configured to receive one or more inputs from the user for use in the dynamic prompt generation.

At act 254, associate the one or more inputs with one or more placeholder elements to generate a first set of prompt clauses. In some examples, a first input of the one or more inputs may be associated with a first placeholder, and a second input of the one or more inputs may be associated with a second placeholder and so on. The inputs and placeholder associations may then be used to generate one or more prompt clauses associated with the placeholders. The first input may be associated with the first placeholder by presenting a first input box configured to receive the first input, and the second input may be associated with the second placeholder by presenting a second input box configured to receive the second input.

Optionally, at act 255, a second set of prompt clauses may be generated based on one or more keywords identified in the one or more inputs. In some examples, separate and distinct from placeholder web form elements, the processor may also scan for one or more keywords, where a keyword may be a word or phrase or numerical string or otherwise specified in the system that may trigger the inclusion of a specific additional prompt. For example, if a user mentions a recent current event as part of the input the processor may recognize the current event as a keyword and insert a prompt clause associated with that event. The prompt clause associated with that event may instruct a machine learning model to incorporate the current event when generating one or more outputs. Additionally or alternatively, the prompt clause may instruct the machine learning model to include information associated with the current event or other keywords as part of one or more outputs. For example, a user may mention a psychological condition that impacts communication such as Alzheimers. The prompt clause may instruct the machine learning model to add an output like the following: “Communicating with Someone Who Has Alzheimers”: “List websites which index peer-reviewed articles on Alzheimers in [language]” or “Provide a list of blogs or organizational websites for caregivers of people with Alzeimers with information addressing communication challenges and advice.” The placement location of this clause in the final prompt may be stored with the keyword and associated clause in a database.

Additionally, the memory may store more than one plurality of keywords. For example, a first plurality of keywords may be associated with a specific user group while a second plurality of keywords may be associated with a second user group. Thus, the processor may only include the phrase surrounding a specific recognized keyword when a user of the system is identified as being part of the specific user group with which the keyword is associated. Additionally or alternatively, a plurality of keywords may include a plurality of global keywords that the processor recognizes and includes in the dynamic prompt generation no matter what group the user may be associated with.

In some examples, at least some of the one or more inputs may be optional inputs. When the user inputs any additional/optional inputs, the additional keys may similarly be associated with the additional/optional inputs. However, when the user does not input a particular optional input, the placeholder associated with the optional input may instead be associated with an empty string or other null value. In that way, the user may dynamically choose which inputs to include in the prompt versus not include in the prompt.

At act 256, a prompt may be dynamically generated based on the first and second sets of prompt clauses. For example, when a placeholder is associated with a user input, a prompt clause associated with that key may be included in the generated prompt. However, when a placeholder is associated with an empty string or null value, for example, when a user does not input an optional input, the prompt clause associated with that placeholder may be left out of the prompt. For example, when the user inputs their age, the placeholder [my_age_user_input] may be associated with that age (e.g. [my_age_user_input]=32). The placeholder may additionally be associated with the prompt clause [my_age]: “I am [my_age_user_input] years old.” In dynamically generating the prompt, the prompt clause associated with the [my_age] placeholder may be included in the prompt where the placeholder is replaced with the user input (e.g., [my_age_user_input]=32: “I am 32 years old”). When the user does not input a value for [my_age], the placeholder may be associated with an empty string or null value rather than the prompt clause (e.g., [my_age]=“ ”:“ ”), so as to leave the particular prompt clause out of the dynamically generated prompt. In doing so, greater dynamism and flexibility may be achieved as opposed to using a static prompt and merely replacing the various placeholders embedded in the static prompt with the user inputs. In some embodiments, the dynamically generated prompt may be generated in any suitable format.

The dynamically generated prompt may then be used as input to a machine learning model such as a large language model (LLM). In some embodiments, the machine learning model may be a deep learning model. In some embodiments, the machine learning model may be a text based generative machine learning model configured to generate text, photo, video, audio, or any other suitable output. For example, the text-based generative machine learning model may include any generative artificial intelligence (AI) application programming interface (API) such as, for example, OpenAI's GPT3, GPT4, DALL-E 2, Xai's Grok, or any other suitable AI API.

In addition to dynamically generating the prompt to be used as input to the machine learning model, the tool may additionally dynamically determine which outputs the tool may provide based on which inputs the user may provide. For example, in some embodiments, the various placeholders may, in addition to being associated with a specific user input and prompt clause, be associated with a specific output clause or output type. For example, the placeholder [my_age] may be associated with a specific output, such as an [age_recommendation] output including information based in part on the prompt and information associated with the age demographic. In some examples, the outputs of the machine learning model may be generated in JSON format, or any other suitable format.

It can be appreciated that the output of a machine learning model may not be adequate and/or accurate. For example, the machine learning model may generate an incorrect or nonsensical output or may misinterpret the instructions so that the output is not suitable to the user. As such, a tool (e.g., button(s)) may be provided to allow the user to provide a feedback input in response to one or more outputs generated by the machine learning model. The machine learning model may then be updated based at least in part on the feedback input. For example, the tool may include a like and dislike button. When a user clicks the like button, the machine learning model may strengthen the connections (e.g., weights and activation functions) of the machine learning model to reinforce a similar output. When a user clicks the dislike button, the machine learning model may adjust the connections (e.g., weights and activation functions) the better determine outputs. In some examples, the feedback input may be indicative of the effectiveness of the message output. For example, the system may prompt the user to describe how the message landed with the recipient and whether the user got a positive response from the recipient to the message generated by the tool. In that way, the machine learning model can learn how to provide a more effective message.

### Movie Recommendation Example

As an illustrative example, given a prompt where [my_age] and [my_gender] are required inputs, and [favorite_movies] and [favorite_genres] are optional inputs, the user may input the required inputs and one or more of the optional inputs to generate a prompt for a machine learning model to determine movie recommendations based on the user's inputs. If the user inputs both optional inputs, the placeholder associations may follow as:
[my_age]: “I am [my_age_user_input] years old,”
[my_gender]: “I am a [my_gender_user_input],”
[favorite_movies]: “I've seen lots of movies myself, but some of my all-time favorites are [favorite_movies_user_input] and I'd like you to make recommendations based on these. You can consider the type of movie (comedy, thriller, action), as well as the director, the writer, the style, and the main actors,”
[favorite_genres]: “Additionally, consider that my favorite genres of movies include [favorite_genres_user_input],”
   However, when, for example, the user does not provide an input for [favorite_genres], the placeholder associations may follow as:
[my_age]: “I am [my_age_user_input] years old,”
[my_gender]: “I am a [my_gender_user_input],”
[favorite_movies]: “I've seen lots of movies myself, but some of my all-time favorites are [favorite_movies_user_input] and I'd like you to make recommendations based on these. You can consider the type of movie (comedy, thriller, action), as well as the director, the writer, the style, and the main actors,”
[favorite_genres]: “ ”
   In each case, the placeholder may then be associated with the user input and may be replaced in the generated text of the prompt by the user input. For example, if the user inputs The Big Lebowski and Field of Dreams as their favorite movies, the favorite movie placeholder may be associated as:
[favorite_movies_user_input]=“The Big Lebowski and Field of Dreams”
[favorite_movies] “I've seen lots of movies myself, but some of my all-time favorites are The Big Lebowski and Field of Dreams and I'd like you to make recommendations based on these. You can consider the type of movie (comedy, thriller, action), as well as the director, the writer, the style, and the main actors,”
   To dynamically change the output based on user input, the machine learning model may be requested to output specific information based on which inputs the user has input. For example, [my_age] may be associated with the output [age_recommendation]. When [my_age] is inputted, the machine learning model may be configured to output a value for the [age_recommendation] output. For example:
[my_age]: “I am [my_age_user_input] years old”
   For the portion of the prompt that defines the output such as a JSON data structure:
{
“movie_recommendations”: “Here you will output movies that I would like based on your knowledge of movies and me”,
[age_recommendation]
}
   In some examples, the placeholder [age_recommendation] may be replaced with:
“movies_for_people_your_age”: “Here you will put movies that people who are [my_age_user_input] years old would like”,
   which may be a key/value pair that defines the name of the output and the instructions for the machine learning model to generate the value associated with that key in the JSON output. It can be appreciated that formats and data structures other than JSON data structures may be used, as the technology described herein is not limited in that manner.
   .”

### Communication Aid Tool

As discussed above, digital communication has expanded the ability of humans to communicate in different ways, styles, and languages and also increased the pace of communications, demands for rapid responses, and risks and rates of mistakes and misunderstandings. However, the broadening ability to communicate more and in more varied contexts, may increase rather than reduce the difficulty of learning and employing effective communication principles in all situations. Therefore, providing for dynamic prompt generation with a generative machine learning model may provide an effective way to model and support more effective communication as well as to teach users of the system how to communicate more effectively in a multitude of situations. For example, a new doctor may not understand the intricacies of communicating difficult news to a patient. Nor may a human resources representative know how to effectively communicate with an employee regarding a complaint. Schoolchildren whose peer engagement was limited during COVID may benefit from support and modeling to fill in deficits in their social and emotional learning from that period. Thus, an effectively generated dynamic prompt may allow a machine learning model to help users of varied backgrounds and contexts to determine/generate one or more effective ways of communicating nuanced information in ordinary and unique situations and to learn from this modeling and an interface that provides feedback, insights, and the emotional rewards of successful responses to user efforts to communicate offline. As such, the techniques described herein may provide an effective and flexible tool to generate prompts for machine learning models that can be used to determine/generate better messages and to provide insights to users regarding how a person can communicate more effectively with varied communication partners in a variety of contexts.

When using dynamic prompt generation as a communication aid, some user inputs may be required inputs whereas other inputs may be optional. For example, a first input of the one or more inputs may be a message input indicative of a message that a user wants to communicate. Other inputs of the one or more inputs may include one or more contextual inputs indicative of the context or circumstances surrounding the message that the user wants to communicate. For examples, the contextual inputs may include the goal of the message (e.g. to respond, to persuade, etc.), the audience for the message, information regarding the audience (e.g. relationship to the user, demographic information of the audience, etc.), information about the situation (e.g. circumstances that may affect the communication, form of communication, whether the communication is a repeated communication, etc.), or any other contextual information that may be helpful for the machine learning model to effectively aid in the communication.

The web form presented to the user may be configured to require a subset of the one or more inputs, for example, the message input and a subset of the one or more contextual inputs, while leaving the other inputs of the one or more inputs optional. For example, the message input and the audience input may be required inputs, and the other contextual inputs may be optional inputs. In that way, a user may have the flexibility to either limit or provide additional contextual information that may help the machine learning model effectively aid the user with their communication. Additionally or alternatively, the web form, or other user interface described herein, may be presented when the user is using any text-based application of the user input device. For example, the web form may be provided as a plug in on web browser or mobile device that presents the user with the tool if the user is writing a message. The web form may be presented when the user is using a text messaging application on the user input device, emailing in a web browser of the user input device, or any other suitable text-based application.

In some examples, the web form may include a plurality of user interface controls that permit the user to provide the one or more contextual inputs associated with the message to be communicated. The web form may provide a tool (e.g., button) that indicates a type of message to be communicated. The web form may provide a specialized textbox for the type of message to be communicated in response to the user selecting the tool indicating that type of message to be communicated. For example, the web form may provide a tool that indicates that message input from the user is a response to a message from another person (e.g., the recipient of the message to be communicated). When the user selects the tool indicating that the message input is a response, the web form may provide an additional textbox for the user to input the message being replied to.

The machine learning model may generate one or more outputs based on the inputs provided by the user. In some examples, a first output of the one or more outputs may include a rewritten message. For example, the dynamically generated prompt may instruct the generative machine learning model to generate a rewritten message based at least in part on the message input and/or one or more of the contextual inputs. The machine learning model may be trained using communication principles, relational principles, one or more communication styles, culture-specific norms, psychological considerations, or ethical considerations and principles. The processor may use the one or more contextual inputs to dynamically generate a prompt configured to cause the machine learning model to call upon these norms, principles, and considerations to generate a rewritten message based on the message input, contextual input, and these norms, principles and considerations.

In some embodiments, the machine learning model may be further fine-tuned based on prior experiences with a particular user and/or a particular recipient of a message. For example, when a user uses the communication tool to generate a message, details associated with the user, message, recipient, relationship between the user and recipient, or any other suitable information may be used to further fine tune or inform the machine learning model when generating the one or more outputs. This information may also be used to preprocess one or more of the inputs to better generate the outputs, as well as reducing the computational load of generating the outputs. For example, rather than having to generate outputs based on an entire conversation history between a user and a recipient, the system may determine particular communications to provide as input to the machine learning model to better target a desired output.

In some examples, other outputs of the machine learning model may include feedback outputs configured to coach the user to improve their communication skills and instruct the user of the system on the communication norms, principles and other considerations. For example, in addition to the rewritten message, the one or more outputs may include a second output including feedback on the original message input. For example, the second output may let the user know that the tone of the original message in the message input was too combative for the purpose of the original message. Additionally or alternatively, the second output may include information regarding the changes made to the original message in the message input. For example, the second output may indicate the changes made to the original message to soften the tone of the rewritten message to be conducive to the purpose of the message. In some examples, the dynamically generated prompt may instruct the machine learning model to generate the second output based on the user input and the communication and relational principles and other considerations on which the machine learning model is trained. Although this coaching is discussed in the context of a communication tool, it can be appreciated that the technology is not limited in this manner. For example, the machine learning model may produce one or more outputs that coach the user to improve one or more skills, for example, skiing, fishing, drawing, golfing, or any other skill. The skill to be coached may depend on the generated prompt and/or the one or more user inputs that a user may input to the system.

Additionally or alternatively, the one or more outputs may include a third output including suggestions for additional steps to be taken outside the original message. For example, the machine learning model may determine that more contextual information may be helpful. The system may then provide an output indicative of what additional contextual information may be helpful for generating the rewritten prompt. In some examples, the output indicative of what additional contextual information may be helpful may include a tool (e.g., a button) configured to allow the user to submit another set of user inputs using the previous user inputs and additional user inputs including the contextual information that may be helpful. Alternatively or additionally, the dynamically generated prompt may instruct the machine learning model to provide suggestions indicative of how to convey the rewritten message. For example, the machine learning model may determine, based on the communication principles and ethical considerations, that a face-to-face conversation may be the best way to convey a particularly difficult message. The machine learning model may thus provide an output suggesting that the rewritten message be delivered face-to-face, and may include an explanation as to why. Thus, through outputs generated based on user input which may include instructions and other support, such as functional buttons, to help the user advance their skill in considering relevant contextual information or otherwise, the user may learn both from the guidance and then from practice considering relevant contextual information when formulating and delivering communications. Beyond this, a user may learn from the emotional and cognitive impact of seeing improved (or less effective) results in the next iteration of the output. As this learning becomes more integrated with practice, user behavior may change even without this scaffolded “prompting” by the system and also even when not using the system. Measurements of user messages and feedback from users about guidance provided, as described below, may illuminate this learning process to help improve it for individual users and in general.

Additionally or alternatively, the one or more outputs may include a fourth output providing a translation of the rewritten message into a language selected by the user. If the user provides a user input selecting that the message is to be conveyed in a particular language, the dynamically generated prompt may cause the machine learning model to provide the additional fourth output including the translated rewritten message. One or more other outputs may similarly be associated with a language input as described with respect to the dynamic outputs above. For example, the machine learning model may be trained on cultural norms of various communities or countries with different native languages. The machine learning model may generate the rewritten message based at least in part on those cultural norms, and may provide an additional output explaining how the relevant cultural norms affected the rewriting of the message.

Additionally or alternatively to the text-based outputs described above, in some examples, the dynamically generated prompt may instruct the machine learning model to evaluate one or more dimensions of the original message and/or the rewritten message. Alternatively, in some examples, a separate prompt than the dynamically generated prompt may be used to instruct the machine learning model to evaluate the one or more dimensions. In that way, the metrics of messages of the user and those generated by the machine learning model may be kept independent. For example, the one or more dimensions may include: actionability, assertiveness, brevity, clarity, dignity, empathy, persuasiveness, relevance, structure, tone, or any other relevant dimension of the various messages. For example, the prompt may instruct the machine learning model that an “actionability” metric measures the extent to which the message prompts action or decision-making and high scores are for messages that clearly outline recommended actions or decisions. In some examples, the machine learning model may evaluate each dimension on a 100 point scale. The machine learning model may output the associated metrics and dimensional scores to the user. In some examples, the output may include dimensional scores for both the original message and the rewritten message to provide the user with an objective comparison between the two messages. These metrics of varying dimensions of the messages may provide the user with additional insight into the individual user's challenges or tendencies as a communicator, consider the dimensions of messages most important with particular recipients of the messages, consider how the tool may impact communication in a group that the user or recipient may be a part of so as to illuminate the user's contextual understanding of their communication abilities and challenges, and to consider potential impact of the tool.

In some examples, the system may store the one or more metrics of the original message and/or the rewritten message in a memory. The one or more metrics may be stored associated with a user who may also be associated with a group. In that way, the user or user group may track the various metrics evaluated by the machine learning model between the original message and/or the rewritten message over time (e.g., for each submission by the specific user, or a user in the user group). Alternatively or additionally to storing the metrics, the prompt may instruct the machine learning model to evaluate a group of submissions (e.g., the last 5, 10, 15, etc. submissions submitted by a specific user or user in a user group). The specific user or user group may track the evolution of their communication skills over time or according to other criteria (e.g., their messages relating to negotiating for themselves or apologizing or their messages to one particular recipient). For example, with each submission, the scores between the original message and the rewritten message may converge, indicating improvement of the user's or user group's communication skills or learning of other communication principles. In some examples, the system may cause both individual metrics as a set of scores, or a group of metrics associated with a certain number of submissions by the user or users in the user group as a graph, to be displayed to a user of the system (e.g. in a user interface as discussed further below).

### Input Validation

The inventors have further recognized and appreciated that text-based generative machine learning may be prone to seemingly coherent, yet nonsensical outputs. For example, a user input may include typos or grammatical errors that may render the input partially or fully nonsensical. Further, this can happen particularly when there is a very large prompt with detailed instructions for the output for the machine learning model that relies upon only small bits of information entered by the user. As such, the inventors have developed methods and techniques for minimizing the probability of poor quality outputs generated by generative machine learning.

In some aspects, a method for minimizing the probability of poor quality outputs generated by generative machine learning may be provided. In some embodiments, the method may start by providing each of the user's inputs to a language identification model. For example, the language identification model may include a language identification API such as Google Translate or DeepL. The language identification model may return a language and/or a confidence score. In some examples, the confidence score may be represented by a floating-point value between 0 and 1. The method may determine whether the user input is a valid user input allowed by the system. For example, if the language returned by the language identification model is not supported by the system, the system may determine that the user input is not valid. Alternatively or additionally, if the confidence score is less than a threshold score (e.g., 0.9, 0.8, 0.75, etc.), the system may determine that the user input is not valid.

The system may then store each unique string of user input in a database. Additionally, the system may store the language identification model used as well as the language determination and confidence score. In that way, calls to the language identification model, which may be computationally expensive, may be minimized. Further, storing the strings and language identification model information may additionally allow a user of the system to validate the confidence scores manually. In some embodiments, an admin user interface may be provided and configured to allow a user to review and enhance confidence scores to improve the system, language identification model, and minimization of calls to the language identification model. In some examples, to validate the user input, the user input may first be checked against a memory cache. Then, the user input may be checked against the information stored in the database. If the user input cannot be validated with the memory cache, or the database, the method may then provide the user input to the language identification model to determine and store language and confidence score information for that user input, as well as validate the user input as described above.

### Language Rendering

It can be appreciated that in some communications, the sender and recipient may be native speakers of different languages. Thus, in some embodiments, the system may be configured to provide one or more of the outputs of the machine learning model in one or more languages. For example, a user interface of the system may include a user input field allowing the user to specify an output language. In some examples, the user may further be able to specify which outputs of a plurality of outputs should be in a particular language. The user may specify that a first subset of outputs should be outputted in a first language and a second subset of outputs should be outputted in a second language. For example, one output of the plurality of outputs may include a translated message in the first language (e.g., the language of the recipient). A second output of the plurality of outputs may include an untranslated version of the message (e.g., in the language of the send). Further, a user may specify that analytic outputs (e.g., why a message was translated in a particular way) should be outputted in the user's language, while the message output is translated to a recipient's language.

### Specialized User Interface

In some examples, one or more of the above described functionalities may be implemented in a system integrated with a specialized user interface. For example, the system may be operatively coupled with a processing unit and a display. The processing unit may be configured to cause the display to display the web form, receive and process user inputs based on a user's interactions with the web form, provide the processed user inputs (e.g., a dynamically generated prompt) to a machine learning model to generate one or more outputs, and/or cause the display to display the one or more outputs to the user. However, it can be appreciated that multiple processors or other processing units (e.g. GPUs, TPUs, etc.) may each perform one or more of the above described functions separately and may be operatively coupled within the system.

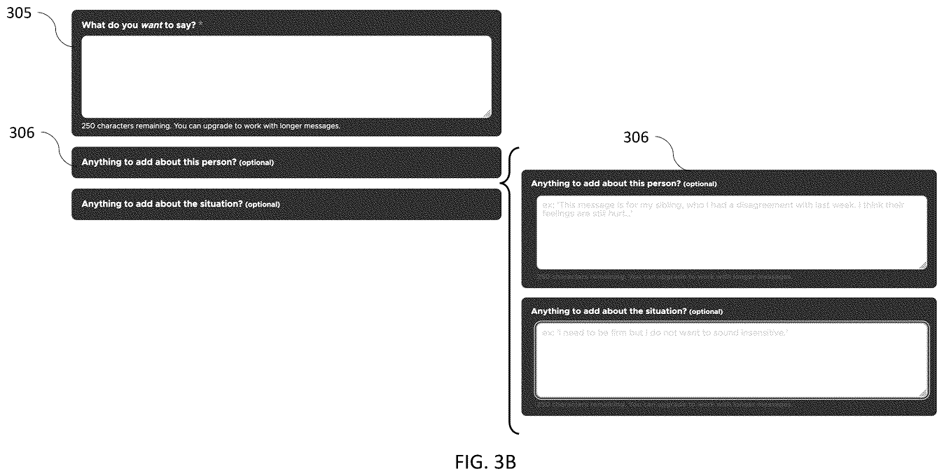

Alternatively or additionally, the user interface may be implemented as a text based chat based on the provided web form. FIGS. 3A-B depict an example user interface 300 for providing one or more content and contextual inputs to a machine learning assisted communication tool, according to some embodiments. In the illustrated embodiment, user interface 300 includes one or more fields (e.g., 302, 305, 306) for providing one or more user inputs. The fields may include content input fields (e.g., 305) for providing input indicative of the message to be communicated and/or one or more contextual input fields (e.g., 302 and 306).

In some embodiments, the processor may cause a first prompt of the web form to be displayed to the user, for example, as a text message. In response to the first prompt, the user may input a first user input responding to the prompt. For example, the first prompt may introduce the tool and ask the user what their goal is. In some examples, the first prompt may allow for an open-ended response and the system may allow the user to input free form text. In some examples, the prompt may allow for a response to be selected from a list of responses, for example, in a multiple choice format. In the illustrated embodiment, field 302 provides both free form text response in text box 304, as well as one or more selectable visual indicators (e.g., buttons, sliders) to provide input as a selection. Field 305 provides only free form text responses, although the technology is not limited in this manner, and any suitable form of response may be enabled (e.g., screenshot). In some embodiments, one or more fields may be indicated as “optional” and may be displayed in a collapsed form. Upon selection of an optional field (e.g., 306, the field may expand to allow a user to enter a response, for example, as depicted in FIG. 3B.

Upon the user providing their response, the system may individually validate the first user input, for example, as described above. If the first user input is not validated, the processor may cause a prompt asking for clarification to be displayed to the user. If the first user input is validated, the processor may cause the second prompt from the web form to be displayed and the user may input a second user input in response to the second prompt. The system may then dynamically generate a prompt as described above using the first user input, second user input, and any additional user inputs responsive to additional prompts the processor may display to the user.

In some examples, rather than a display operatively coupled to the system, a voice interface may be operatively coupled to the system. For example, the voice interface may be a digital assistant such as Amazon Alexa, Siri. Alternatively, the voice interface may include a display that would display a visual form of the prompt, a voice detection component (e.g. a microphone) configured to detect speech of the user, and the processor may be further configured to recognize the speech of the user from the detected speech. Additionally or alternatively to iteratively displaying to the user various prompts from the web form, the processor may be configured to cause the voice interface to output a first audio signal with the first prompt and a second audio signal with the second prompt. The user may interact with the voice interface in the same manner as described above with respect to the text based chat. The user may choose a particular voice for the machine learning model such as a mentor, celebrity, parent, etc.

In some examples, the user interface may be configured to display the prompts and outputs of the system in one or more modalities. For example, the user interface may display the prompt or output in a display of the user interface. The user interface may additionally or alternatively cause an audio output device (e.g., speaker) to output an audio signal including the prompt or output of the system. In some examples, the user interface may provide the prompt or output in both visual and audio form to the user.

In addition to the above described functionality, the user interface may provide additional functionality, described further below, to enhance the user experience with the user interface and system as a whole.

In some examples, the system may include a dossier function configured to store previously generated prompts with a particular context. For example, the user input into the system may include a name of an individual to receive a message. The user input may additionally include information associated with the individual, for example, the individual's relationship to the user, contextual information (e.g., the individual's feelings about the user), or any other information that may be associated with the individual. After providing the user input a first time, a processor may cause the information to be stored in a memory of the system wherein the information is associated with the individual in the memory. When the user uses the system again, the user interface may update to include tools for the user to select the individual and the associated information rather than having to input the additional information associated with the individual again.

In some examples, the system may additionally or alternatively include a filing system configured to store past submissions to the system for retrieval rather than having to input all the information associated with the submission again. The system may store in a memory all of the information associated with the user input used to dynamically generate a particular prompt. The system may store the past submissions as associated with a particular user and/or user group. When using the tool, the user interface may include an output displaying a list of previous submissions with the associated user inputs. In some examples, the user interface may display the previous submissions in a list where each previous submission is displayed in a collapsible entry. The collapsible entry may include various information associated with the respective previous submission. The information may include a title, the date and time of the submission, or any other suitable information. Each collapsible entry may further include a tool (e.g., a button) to expand the collapsible entry to view detailed information of the previous submission. The detailed information may include each prompt for which the user provided a user input, as well as one or more of the outputs generated by that submission. In some examples, each collapsible entry may further include a tool (e.g., button) configured to allow the user to modify and resubmit the previous submission to the system.

In some examples, the user interface may include a tool (e.g., a button) configured to allow the user to share one or more of the outputs generated by the system in response to user inputs. It may be beneficial in some circumstances to allow this sharing to be anonymous and not tied to a particular user. Using the tool may create a digital ID associated with a particular exchange. The user may have the option of controlling whether to cause the exchange to be shared with reference to the anonymous digital ID of the exchange. Additionally or alternatively, the user may make a link to the exchange visible publicly without referring in any discernible way to the user who created or shared the exchange. Further, the user may at any time change the permissions associated with an exchange to enable other people to view the exchange or to deny access to the exchange.

In some examples, the inventors have recognized and appreciated that the various functions described herein may take time to generate a response, for example, 15 seconds, 30 seconds, 90 seconds, or any amount of time depending on the complexity of the dynamically generated prompt and various user inputs. As such, the processor may cause the user interface to display a waiting message to the user. In some examples, the waiting message may be tailored to the specific user of the system. For example, the user may be associated with a particular user group. The system may store various messages associated with the user group in a memory of the system. The processor may cause the user interface to display one or more of the messages associated with the user group to the user. In some examples, the one or more messages may be displayed on a rotating basis, for example, the message may rotate every few seconds or may rotate whenever the user submits a new user input. In some examples, one message may be displayed for the entire waiting period while other messages may be displayed on a rotating basis. These waiting message can support the learning/coaching aspect of the system. For example, the messages or images can support the cognitions or emotional state which can aid users in their learning and application of principles of communication or other relevant content.

### Educational Features

As described above, it can be appreciated that the techniques and methods described herein may provide an effective coaching tool for a user to improve one or more skills (e.g. communication with respect to the communication tool described above). As such, one or more additional educational features may be provided to augment the coaching capabilities of the technology described herein.

In some examples, the machine learning model may determine one or more outputs indicative of additional information that may be relevant and useful for the dynamically generated prompt to include. For example, when being used as a communication aid tool, one of the one or more outputs may prompt the user to provide additional relationship information between the user and a recipient of a message to be communicated. This information may help the machine learning model adjust a message output to better suit and specialize the relationship between the user and the recipient. In some examples, the output may be displayed in a user interface near a tool (e.g., button) that may allow the user to input the additional information without having to reenter the user inputs originally provided by the user.

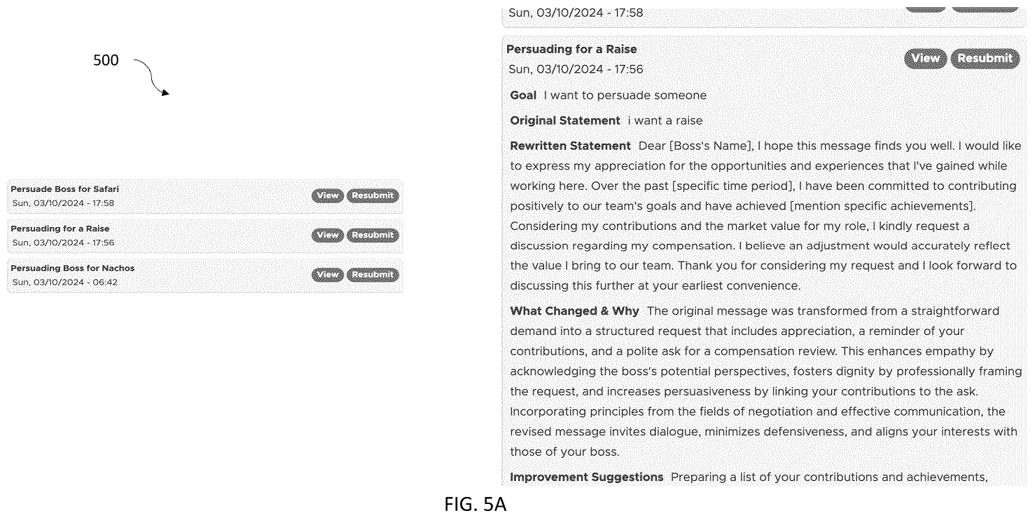

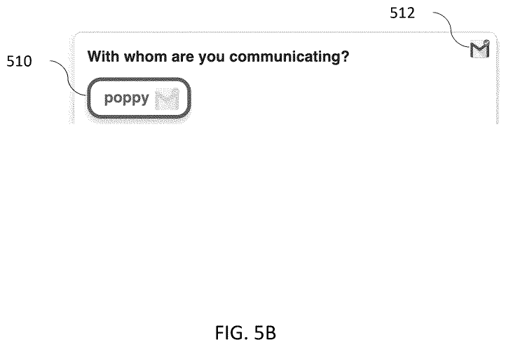

FIG. 5A depicts an example user interface 500 providing one or more outputs associated with a message to be communicated generated by a machine learning assisted communication tool, according to some embodiments. The display may include a list of collapsable selectable items, each associated with a different digitalID of a previous message to be communicated. Upon selection of an item, the item may expand to display the one or more outputs which may include information indicative of the inputs (e.g., goal, original statement) and the one or more outputs (e.g., rewritten statement, what changed & why). In that way, a user can reread the generated message as well as the other additional outputs to learn how to better communicate based on their previous experiences.

In some examples, roleplaying may be a helpful coaching tool, for example, to aid users in communicating. Accordingly, in some examples, one of the one or more outputs determined by the machine learning model may include one or more predicted responses to a message to be communicated. The machine learning model may provide the one or more predicted responses to the user so that they may better anticipate any unexpected responses from an intended recipient of the message to be communicated. In some examples, the machine learning model may be configured to generate an audio or visual signal of the predicted response. The machine learning model may then provide the audio or visual signal of the predicted response to an audio output device (e.g., speaker), so that the user may hear the predicted response. In some examples, the user may upload a voice sample of the intended recipient of the message to be communicated and the machine learning model may generate the audio signal in the voice of the intended recipient. In some examples, the user may upload visuals of the intended recipient so that the user may practice communicating with an avatar of the intended recipient.

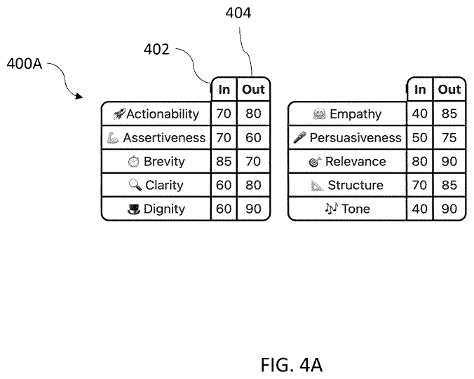

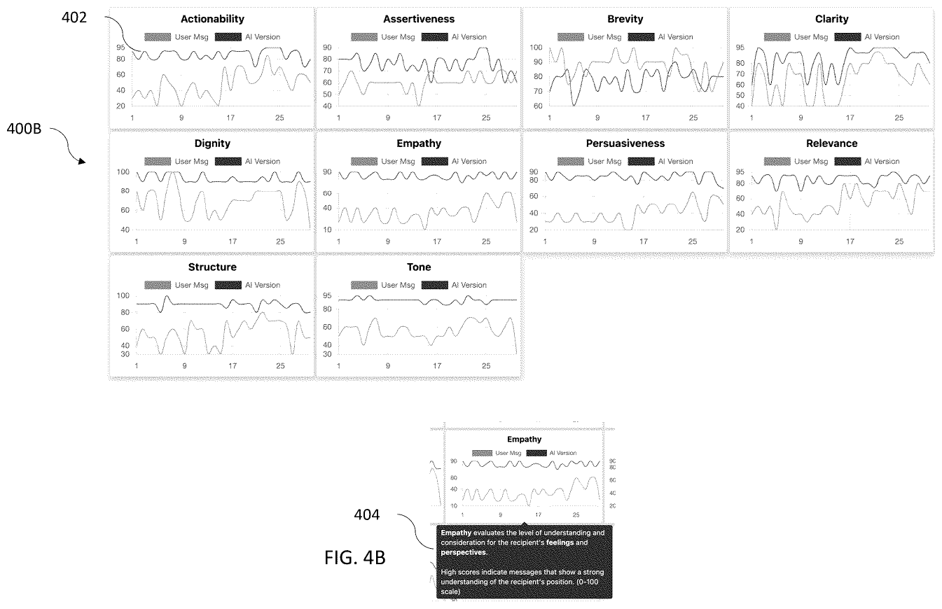

Further, in some embodiments, the system may provide the metrics (e.g., “actionability”) associated with the message to be communicated. FIG. 4A depicts an example display 400A providing one or more metrics associated with a message to be communicated, according to some embodiments. FIG. 4B depicts another example display 400B providing one or more metrics associated with a message to be communicated, according to some embodiments.

As shown in FIG. 4A, the system may provide metrics associated with a single message in display 400A. Any of the above described metrics may be provided although an example list is depicted in FIG. 4A. In some embodiments, display 400A may display scores associated with the original message in a first section (e.g., column 402) and displays scores associated with the rewritten message in a second section (e.g., column 404). In that way, a user may see how the rewritten message compares with the original message on a metric-by-metric basis.

Additionally or alternatively, as shown in FIG. 4B, the system may provide metrics associated with a series of messages. In that way, a user may track the improvement of their own original messages as compared with the rewritten messages. As the values of the metrics converge between the original and rewritten messages, a user may take this as an indication of improvement. Each metric in display 400B may include an associated graphical representation 402 of scores across the series of messages. Additionally, when a user hovers over a particular metric (e.g., with a mouse or other selector) display 400B may provide additional information associated with the metric (e.g., a definition and/or description of relevancy). In some embodiments, the system may display the additional information as overlay 404, or may display the information in a pop-up window, or separate section of the window in which the graphical representations are displayed.

### Linked Persona

In some embodiments, users may link one or more communication platforms or tools with the machine learning-based communication tools described herein. For example, a user may link one or more email accounts or social media accounts to a “persona” associated with the user. When the accounts are linked, the tools described herein may utilize information about the user's previous communications via that account to duly inform the machine learning models on how a particular user communicates. In that way, more quality information may be fed to the machine learning models to generate better responses, suggestions, and analyses.

In some embodiments, the one or more communication platforms may be an email account. In some embodiments, the account may be a cloud-hosted email account, such as Google Gmail or Microsoft Outlook. In some embodiments, the account may be connected using OAuth or any other suitable authorization method.

A user may be able to selectively control which account(s) may be accessed as well as which communications (e.g., email, text message, social media message) may be accessed by the tools described herein. In that way, the tool may retrieve one or more communications associated with a desired message/prompt to be communicated as described herein. For example, if the user is trying to communicate with a colleague, the tool may retrieve one or more prior communications with said colleague from the linked account(s) to better inform the output message generated by the machine learning model. In some embodiments, one or more of the contextual inputs used to generate the prompt and inform the machine learning model may be received from the communication platforms upon the user providing a selection of the communication platform and/or authorization information for the communication tool to access the communication platform.

FIG. 5B depicts an example display for linking a persona with a communication platform, according to some embodiments. Visual indicator 512 may indicate that a communication platform (e.g., a Gmail account) has been authorized (e.g., via the OAuth process). However, a user may still perform steps to link the authorized communication platform with a particular persona. The grayed out visual indicator 510 may indicate that, while the account has been authorized, the communication platform is not linked with the persona and selecting the visual indicator 510 may cause the communication platform to be linked with the “poppy” persona. In some embodiments, the display may include more than one visual indicator 512 to indicate multiple communication platforms have been linked, and/or more than one visual indicator 510 to indicate multiple personas that the communication platform(s) may be linked to.

By creating a “persona” in the AI tool that represents a person or other party with whom the user will be communicating, the user may then associate one or more of their own personal OAuth enabled email accounts to this persona and may then specify one or more of the persona's email addresses which may be used to limit the data retrieval to only specific communication (email exchanges) between the user and the persona(s) with whom they have interacted and may interact in the future. For example, the system may determine that particular messages between a user and the intended recipient are relevant to the current message to be communicated, and thus, may selectively choose those messages to provide as contextual inputs during prompt generation or as input to the machine learning model. By determining the relevance, the computational workload may be reduced by only providing messages with more relevance as contextual inputs rather than an entire conversation history.

Additionally or alternatively, in some embodiments, the system may preprocess one or more inputs received from a linked communication platform. The preprocessing may include providing the message history associated with the communication platform as insight to a machine learning model. The model may be trained to determine one or more contextual inputs regarding the messages in the message history. The contextual inputs may include, for example, insight about each sender or recipient of the messages, the nature of the relationship with the user, what communication approaches may work best with the various persons, or any other suitable information. In that way, when analyzing a message history with a large number of messages, the machine learning insights may be provided along with a subset of the messages, rather than the entire message history. In some embodiments, performing the machine learning insights in this manner may be done periodically, for example, weekly or monthly. In that way, computational workload may be decreased by reducing the amount of input data to parse through when using the communication tool.

In some embodiments, the tool may also enable users to upload screenshots of message exchanges in order to enrich the “persona.” For example, the user interfaces described herein may provide one or more fields for entering communications in text or image form.

The “persona” may provide a number of advantages over conventional email integration systems and techniques by: enabling precise user control over which accounts and conversations the user shares with an AI system or tool, as opposed to blanket permission for the scraping of all emails; enabling the ability to associate multiple email accounts and even platforms of both the user and the persona so that a more precise representation of the communication styles may be attained, e.g. of behaviors and past important conversations and events such as sales or life transitions or disagreements; enabling the ability to associate additional data with a persona such as but not limited to the user's own opinions about the persona, the persona's online profile information such as level of education and skills (via LinkedIn for example), etc; enabling the ability to allow users to upload screenshots of text message exchanges (which do not have the same level of accessibility provided by OAuth technology) and to incorporate their content into the communication history between the user and the persona.

The “persona” technique may additionally provide improved goal-based communication assistance, coaching, and relevant positive and educational feedback about how an initial message input was changed to enhance it vis-à-vis its stated purpose, follow up tips and suggestions with a focus on relationship of specific parties involved in a given communication. In some embodiments, the “persona” technique may additionally provide goal-based, relationship-based communication assistance that is tailored to the specific parties involved, including but not limited to their relationship history, their specific history and life contexts, personality features as discernible in communications and as described by the user, cultural influences on communications discernible in communications and described by the user, and the dynamics of their communication with one another in different contexts, as discernible in communications and as described by the user.

By providing specific permissions to the communication tool to access the linked communication platforms, the communication tool may be enabled to enrich user input with content from the user's other communication platforms in order to provide output tailored to the user's communication with a specific person or entity; to scrape specific content from the user's other platforms in order to enrich its output with reference to specific relationships, topics, goals, relational dynamics or other areas of particular interest to this user and which can be generalized to other situations for this user [and others]; to scrape specific content from the user's other platforms, specifically all communications with one or more email addresses or phone numbers or other handles or signifiers specific to a person or party with whom the user communicates, in order to create a “persona” which the user can reference at any time and which will draw on updated real communications with the “persona” associated with those email addresses, phone numbers, handles, or other signifiers, in order to enrich the tool's output with reference to that specific person or relationship; to scrape specific content from the user's other platforms specifically all communications with a “persona” defined by one or more email addresses or phone numbers or other handles or signifiers specific to a person or party with whom the user communicates, and also where the user can provide one or more email addresses for themselves, in order to enable the tool to draw on updated real communications between the user and the “persona” associated with those email addresses, phone numbers, or other handles or signifiers, in order to enrich the tool's output with reference to that specific person or relationship and the different nature of the communication in different channels or media or contexts, and which may be generalized to other situations.

In some embodiments, a user may open a “persona” file (e.g., created and stored in a memory of the system in the first instance) in order to upload screenshots of text message exchanges (which do not have the same level of accessibility provided by OAuth technology) in order to incorporate the content of these communications between the parties into the communication history between the user and the persona and thus into the input when the user uses the tool for support in communicating with this persona.

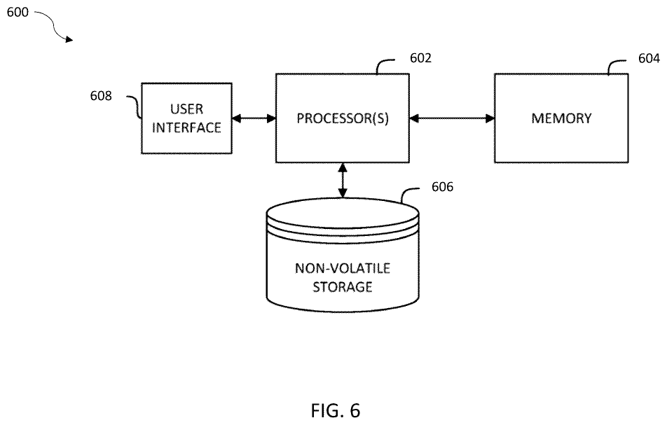

FIG. 6 depicts an example computer-based system on which the system of FIG. 1 may be implemented, according to some embodiments. The computer system 600 includes one or more computer hardware processors 602 and one or more articles of manufacture that comprise non-transitory computer-readable storage media (e.g., memory 604 and one or more non-volatile storage devices 606). The processor(s) 602 may control writing data to and reading data from the memory 604 and the non-volatile storage device(s) 606 in any suitable manner. To perform any of the functionality described herein, the processor(s) 602 may execute one or more processor executable instructions stored in one or more non-transitory computer-readable storage media (e.g., the memory 604), which may serve as non-transitory computer-readable storage media storing processor-executable instructions for execution by the processor(s) 602.

In some embodiments, computer system 600 also includes a user interface 608 (e.g., for displaying user interfaces described herein with respect to FIGS. 3A-5B) in communication with processor(s) 602. The user interface 608 may be configured to display any information generated by the different machine learning models described herein as executed by processor(s) 602.

Having thus described several aspects of at least one embodiment of the technology described herein, it is to be appreciated that various alterations, modifications, and improvements will readily occur to those skilled in the art. Such alterations, modifications, and improvements are intended to be part of this disclosure and are intended to be within the spirit and scope of disclosure. Further, though advantages of the technology described herein are indicated, it should be appreciated that not every embodiment of the technology described herein will include every described advantage. Some embodiments may not implement any features described as advantageous herein and in some instances one or more of the described features may be implemented to achieve further embodiments. Accordingly, the foregoing description and drawings are by way of example only.

The above-described embodiments of the technology described herein can be implemented in any of numerous ways. For example, the embodiments may be implemented using hardware, software, or a combination thereof. When implemented in software, the software code can be executed on any suitable processor or collection of processors, whether provided in a single computer or distributed among multiple computers. Such processors may be implemented as integrated circuits, with one or more processors in an integrated circuit module, including commercially available integrated circuit modules known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. However, a processor may be implemented using circuitry in any suitable format.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, aspects of the technology described herein may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium encoded with one or more programs that, when executed on one or more computers or other processors, perform methods that implement the various embodiments described above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the technology as described above. A computer-readable storage medium includes any computer memory configured to store software, for example, the memory of any computing device such as a smartphone, a laptop, a desktop, a rack-mounted computer, or a server (e.g., a server storing software distributed by downloading over a network, such as an app store). As used herein, the term “computer-readable storage medium” encompasses only a non-transitory computer-readable medium that can be considered to be a manufacture (i.e., article of manufacture) or a machine. Alternatively, or additionally, aspects of the technology described herein may be embodied as a computer readable medium other than a computer-readable storage medium, such as a propagating signal.

The terms “program” or “software” are used herein in a generic sense to refer to any type of computer code or set of processor-executable instructions that can be employed to program a computer or other processor to implement various aspects of the technology as described above. Additionally, it should be appreciated that according to one aspect of this embodiment, one or more computer programs that when executed perform methods of the technology described herein need not reside on a single computer or processor, but the processor functions may be distributed in a modular fashion among a number of different computers or processors to implement various aspects of the technology described herein.

Computer-executable instructions may be in many forms, such as program modules, executed by one or more computers or other devices. Generally, program modules include routines, programs, objects, modules, data structures, etc. that perform particular tasks or implement particular abstract data types. Typically, the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the technology described herein may be used alone, in combination, or in a variety of arrangements not specifically described in the embodiments described in the foregoing and is therefore not limited in its application to the details and arrangement of modules set forth in the foregoing description or illustrated in the drawings. For example, aspects described in one embodiment may be combined in any manner with aspects described in other embodiments.

Also, the technology described herein may be embodied as a method, of which examples are provided herein. The acts performed as part of any of the methods may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The terms “approximately” and “about” may be used to mean within ±20% of a target value in some embodiments, within ±10% of a target value in some embodiments, within ±5% of a target value in some embodiments, within ±2% of a target value in some embodiments. The terms “approximately” and “about” may include the target value.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

1. A method for using machine learning to aid communication, the method comprising:
receiving inputs, via a user input device, the received inputs including:
a message input indicative of a message to be communicated; and
one or more contextual inputs associated with the message to be communicated, each contextual input having an associated context type;
generating a prompt based at least in part on the received inputs and the associated context types of the one or more contextual inputs; and
determining, using a machine learning model, one or more outputs associated with the message to be communicated based at least in part on the generated prompt, at least one output of the one or more outputs being a message output indicative of the message to be communicated based at least in part on the received inputs.

2. The method of claim 1, wherein the prompt comprises a plurality of prompt clauses, and generating the prompt comprises generating at least a subset of prompt clauses of the plurality of prompt clauses based on the received inputs and the associated context types of the one or more contextual inputs.

3. The method of claim 2, wherein at least one prompt clause of the plurality of prompt clauses is generated based at least in part on information associated with a user of the user input device.

4. The method of claim 3, wherein the information associated with the user of the user input device is indicative of a user group the user is part of and/or of a relationship of the user to the user group.

5. The method of claim 1, wherein the prompt is a first prompt, the method further comprising:
receiving, as input to the machine learning model, a second prompt, the second prompt being indicative of one or more metrics of the message input and/or the message output to be evaluated;
evaluating, using the machine learning model, the one or more metrics of the message input and/or the message output; and
providing the evaluated one or more metrics to a user of the user input device.

6. The method of claim 1, wherein at least a subset of outputs of the one or more outputs includes feedback outputs configured to coach a user of the user input device to improve communication skills.

7. The method of claim 6, wherein the feedback outputs include at least one or more of: a changes output indicative of the changes between the message input and the message output, an analysis output indicative of one or more issues with the message input or message output, and/or a suggestions output indicative of steps to be taken by the user.

8. The method of claim 7, wherein one or more feedback outputs of the feedback outputs is indicative of one or more additional inputs to be provided by the user, and the method further comprising:
receiving the one or more additional inputs, via the user input device, in response to the one feedback output;
updating the prompts based at least in part on the one or more additional inputs; and
determining, using the machine learning model, a new set of one or more outputs based at least in part on the updated prompt.

9. The method of claim 6, wherein one feedback output of the feedback outputs is one or more predicted responses to the message to be communicated.

10. The method of claim 9, the method further comprising:
outputting, using an audio output device, an audio signal indicative of the predicted responses, wherein the audio signal is in a voice of an intended recipient of the message to be communicated and/or using a visual output device, a video signal indicative of the predicted responses and/or using an audiovisual device, a combined audiovisual signal indicative of the predicted responses or the intended recipient to the message to be communicated.

11. The method of claim 1, wherein a contextual input of the one or more contextual inputs is a language input indicating whether the message output is to be translated into a language and the message output is generated based at least in part on information associated with the language, the method further comprising:
translating the message output into the language if the language input indicates that the message output be translated into the language; and
translating the message output into a language of the user.

12. The method of claim 1, further comprising:
validating the received user inputs by providing the received user inputs to a language identification model;
receiving a validation metric indicating whether the received user inputs are valid; and
providing an error message to the user if the validation metric indicates that user inputs are invalid.

13. The method of claim 12, wherein the validation metric comprises a language and/or confidence score and the received user inputs are indicated as valid if the language is supported and/or the confidence score is within a threshold range.

14. The method of claim 1, wherein at least one input of the received inputs is stored in a memory and receiving inputs comprises receiving an input via the user input device associated with the stored input and receiving the stored input from the memory.

15. The method of claim 14, wherein at least one output of the one or more outputs is stored in the memory and the memory is configured to accessed by a user via the user input device to allow the user to review and/or share the at least one stored input and/or the at least one stored output.

16. The method of claim 1, the method further comprising:
receiving, from the user input device, a feedback input responsive to the one or more outputs; and
updating the machine learning model based at least in part on the feedback input.

17. The method of claim 1, wherein at least one of the one or more contextual inputs is received from one or more communication platforms with which the user has an account when the user input is indicative of authorization to access the one or more communication platforms.

18. The method of claim 1, wherein at least one of the one or more contextual inputs is determined based on a screenshot of one or more communications between the user and at least one other person.

19. A machine learning assisted communication tool comprising:
a user input device configured to receive one or more inputs from a user, the received inputs including:
a message input indicative of a message to be communicated; and
one or more contextual inputs associated with the message to be communicated, each contextual input having an associated context type; and
one or more processors configured to:
generate a prompt based at least in part on the received inputs and the associated context types of the one or more contextual inputs; and
determine, using a machine learning model, one or more outputs associated with the message to be communicated based at least in part on the generated prompt, at least one output of the one or more outputs being a message output indicative of the message to be communicated based at least in part on the received inputs.

20. A non-transitory computer readable medium storing processor-executable instructions, that, when executed, cause the processor to perform a method comprising:
receiving inputs, via a user input device, the received inputs including:
a message input indicative of a message to be communicated; and
one or more contextual inputs associated with the message to be communicated, each contextual input having an associated context type;
generating a prompt based at least in part on the received inputs and the associated context types of the one or more contextual inputs; and
determining, using a machine learning model, one or more outputs associated with the message to be communicated based at least in part on the generated prompt, at least one output of the one or more outputs being a message output indicative of the message to be communicated based at least in part on the received inputs.

21. A method for using machine learning to coach a user, the method comprising:
providing an interface on a user input device tailored to the user;
prompting a user, via a user input device, for inputs;
receiving inputs from the user, via the user input device, each input comprising content and a context type;
generating a model input based at least in part on the content and context type of each input; and
determining, using a machine learning model, one or more outputs associated with the received inputs based at least in part on the generated model input and the context types of each input, wherein at least one output of the one or more outputs is configured to coach the user to improve one or more skills of the user;
providing one or more outputs in text, audio, visual, and/or audiovisual form responsive to the user selecting text, audio, visual, and/or audiovisual form;
receiving updated inputs from the user, via the user input device, responsive to at least one output configured to coach the user; and
updating the model input based at least in part on the updated inputs.
